(19) United States
(12) Patent Application Publication
(10) Pub. No.: US 2023/0326333 A1
(43) Pub. Date: Oct. 12, 2023

(54) FINGERPRINT MODULATION FOR BEACON

(71) Applicant: Sheaumann Laser, Inc., Billerica, MA (US)

(72) Inventors: John Gary Sousa, Nashua, NH (US); Andrew Carlin, Acton, MA (US)

(21) Appl. No.: 18/185,608

(22) Filed: Mar. 17, 2023

Related U.S. Application Data
(60) Provisional application No. 63/322,307, filed on Mar. 22, 2022.

(51) Int. Cl. G08B 1/08; G08B 5/22; G08C 23/04

(52) U.S. Cl. CPC G08C 23/04; G08B 1/08; G08B 5/22; G08B 5/002

(57) ABSTRACT

A beacon with a preferably anodized aluminum body, cylindrical in shape, and threaded employs a beacon modulation scheme for MWIR/LWIR beacons in which multiple frequencies of emission are overlaid, such as the addition of a high frequency pulse, several orders of magnitude faster than the low frequency blink, the high frequency modulation being beyond the capability of unaided human perception. This modulation would allow a high-speed detector and associated software to lock onto an asset in the presence of background radiation which would otherwise drown out the signal of interest.

### RELATED APPLICATION

This application claims the benefit under 35 USC 119(e) of U.S. Provisional Application No. 63/322,307, filed on Mar. 22, 2022, which is incorporated herein by reference in its entirety.

### BACKGROUND OF THE INVENTION

Deployable At-Sea Mid-Wave Infrared Emitter beacons provide visual position location for combat swimmer / diver personnel during rendezvous / extraction while in the ocean. The beacons often operate within the wavelength range of Mid-Wave and Long Wave Infrared (MWIR/LWIR), which is often defined as 2.0 - 12.5 µm. Compatible imaging and sensing systems are then employed by pilots or spotters on ships, for example, to see and locate the beacons.

The MWIR/LWIR beacons emit in a “halo” of 360°. The halo emission also emits as a divergent output in azimuth both in the positive (towards the sky) and negative directions (towards the ground or ocean surface). FIG. 1A shows the beacon 50 powered off and FIG. 1B shows the beacon 50 on, with its cover screwed down and exposing the axicon.

FIGS. 2A and 2B are a side plan view and a side cross sectional view of the beacon 50.

Shown is the housing 1, the window cap 2, the cylindrical sapphire window, the base mount 4 including the quantum cascade laser (QCL), the contact pad 5, the QCL submount 6, the QCL housing mount 7; printed circuit board 8, cover 9, battery compartment 10, end cap 11, locking sleeve 12, switch slide 13, switch slide lock 14, switch 15, wet plugable connector 16, PCB at the top of the battery compartment 17, and PCB at the bottom of the battery compartment 18.

In operation, the beacon 50 is turned on by screwing the cover 9 down, which also serves as a protective cover when in the off position (fully threaded up) to protect the beacon if dropped.

### SUMMARY OF THE INVENTION

The present invention concerns a beacon modulation scheme for MWIR/LWIR beacons in which multiple frequencies of emission are overlaid, such as the addition of a high frequency pulse, several orders of magnitude faster than the low frequency blink, the high frequency modulation being beyond the capability of unaided human perception. This modulation would allow a high-speed detector and associated software to lock onto an asset in the presence of background radiation which would otherwise drown out the signal of interest. Further, by nesting a pulse train, such as Morse code or other data encoding schemes including packet data, within higher frequency pulse(s) this device could easily be configured as a communications emitter. Finally, the nature of all light emitting devices is that they produce heat as a byproduct of operation and as they heat emission efficiency decreases.

In general, according to one aspect, the invention features a Mid-Wave and Long Wave Infrared beacon generating a fingerprint modulation that can be used to identify an asset while improving asset detection.

Preferably, the beacon nests of a high frequency pulse train in the modulation in a lower frequency blink.

The high frequency pulse train is higher than human perception, and can be have a frequency of greater than 100 Hertz, and even higher than 1 kiloHertz.

The low frequency blink can be less than 100 Hertz.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1A is a side perspective views showing a beacon powered off and FIG. 1B is a side perspective view showing the beacon powered on;

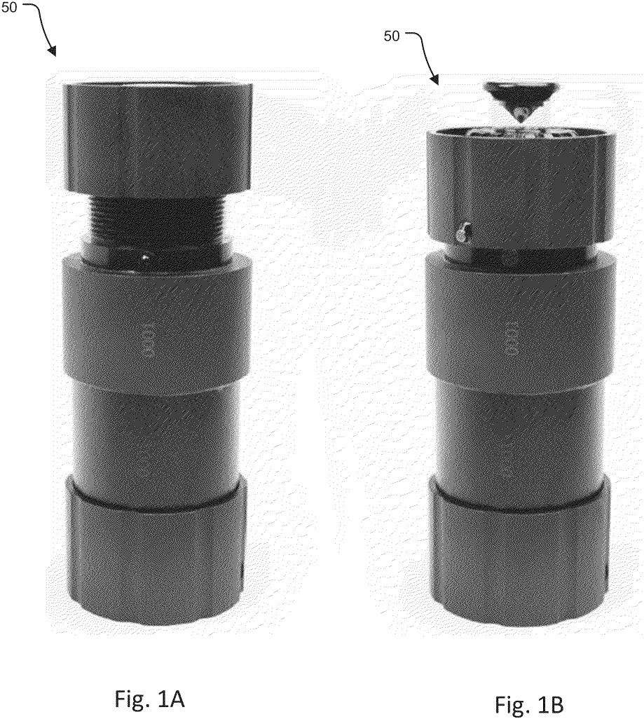

FIGS. 2A and 2B are a side plan view and a side cross sectional view of the beacon; and

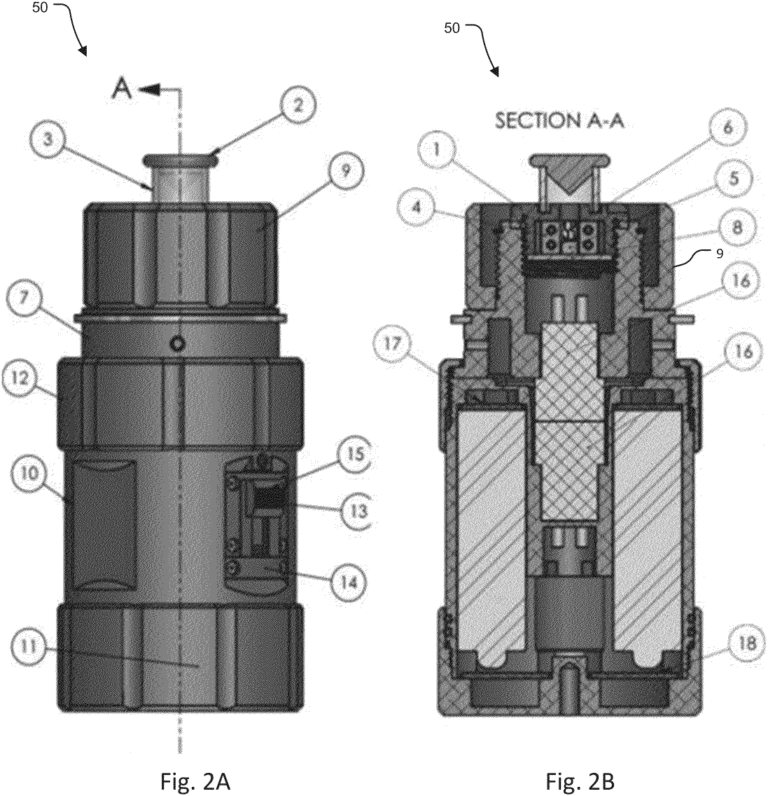

FIG. 3 is a plot of beacon emission as a function of time.

### DESCRIPTION OF THE PREFERRED EMBODIMENTS

The primary metric of any asset location technology is the distance, miles, between the beacon and detector at which the beacon’s signal can be clearly distinguished from background radiation (light noise). Multi-frequency (2+) modulated emission, such as nesting of a high frequency (kHz) pulse within a low frequency (Hz) blink, creates a known ‘fingerprint’ which when paired with a capable detector system would provide a pathway to filtering background radiation by employing lock-in detection, increasing signal (asset) to noise (background) ratio.

Within the wavelength range of Mid-Wave/Long Wave Infrared (MWIR/LWIR) imaging and sensing systems, it can be both a challenge to be “seen” and to “not be seen” with existing technology. The wavelength range of MWIR/LWIR is typically defined as 2.0 — 12.5 µm, within this range many background sources exist which can ‘pollute’ the received signal reducing detection range. This fingerprint frequency modulation allow for both a user interpreting an image and a sensing system to identify its target more easily.

It is a common practice for locator beacons to blink, this is done because distinguishing any locator from background can be difficult based on environmental conditions.

The MWIR/LWIR beacon employs a beacon modulation scheme in which multiple frequencies of emission are overlaid, such as the addition of a high frequency pulse train, several orders of magnitude faster than the low frequency blink, the high frequency modulation being beyond the capability of unaided human perception.

Preferably the low frequency blink is less than 100 Hertz usually less than 10 Hertz.

The high frequency pulse train has a frequency of greater than 100 Hertz and can be higher than 1 kiloHertz.

This modulation enables the use of high-speed detector and associated software to lock onto an asset in the presence of background radiation which would otherwise drown out the signal of interest.

The approach also always the nesting of another pulse train, such as Morse code or other data encoding schemes including packet data, within higher frequency pulse(s) thus, allowing the MWIR/LWIR beacon to function as a communications emitter.

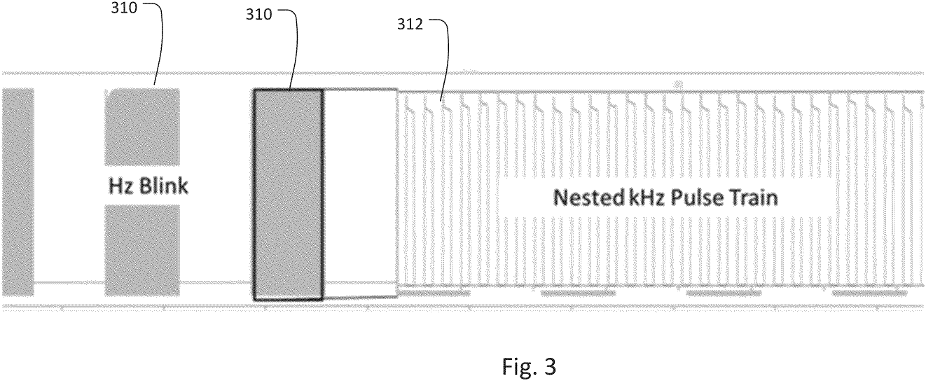

FIG. 3 is a plot of beacon emission as a function of time. It shows ‘fingerprint’ of a low frequency (Hz) blinks 310 with a nested kHz pulse train 312. The precise frequencies can be adjusted through circuitry design.

The implementation of this technology provides additional benefits related to power efficiency vs. detection range relative to continuous wave operation of conventional beacons.

While this invention has been particularly shown and described with references to preferred embodiments thereof, it will be understood by those skilled in the art that various changes in form and details may be made therein without departing from the scope of the invention encompassed by the appended xclaims.

What is claimed is:

1. A Mid-Wave and Long Wave Infrared beacon generating a fingerprint modulation that can be used to identify an asset while improving asset detection.

2. The beacon as claimed in claim 1, further comprising the beacon nesting of a high frequency pulse train in the modulation in a lower frequency blink.

3. The beacon as claimed in claim 2, wherein the high frequency pulse train is higher than human perception.

4. The beacon as claimed in claim 2, wherein the high frequency pulse train has a frequency of greater than 100 Hertz.

5. The beacon as claimed in claim 2, wherein the high frequency pulse train has a frequency of between 100 Hertz and 1 kiloHertz.

6. The beacon as claimed in claim 2, wherein the low frequency blink that is than a 100 Hertz.
